(19) United States
(12) Patent Application Publication
(10) Pub. No.: US 2016/0130159 A1
(43) Pub. Date: May 12, 2016

(54) SYSTEM FOR DETERMINING UV DOSE IN A REACTOR SYSTEM

(71) Applicant: Trojan Technologies, London (CA)

(72) Inventors: Douglas Gordon Knight, London (CA); Farnaz Daynouri-Pancino, London (CA); Brian Petri, London (CA)

(21) Appl. No.: 14/896,507

(22) PCT Filed: Jun. 4, 2014
(86) PCT No.: PCT/CA2014/000480

§ 371 Date: Dec. 7, 2015

Related U.S. Application Data
(60) Provisional application No. 61/956,385, filed on Jun. 7, 2013.

(51) Int. Cl. C02F 1/32; G01J 1/42; C02F 1/00

(52) U.S. Cl. CPC C02F 1/32; C02F 1/008; G01J 1/429; C02F 2303/04

(57) ABSTRACT

The is described a process for determining a validated Reduction Equivalent Dose for reducing the concentration of a target contaminant contained in a fluid in a radiation fluid treatment system. In one embodiment, the process comprises the steps of: (a) determining a short wavelength Reduction Equivalent Dose for the target contaminant or a challenge contaminant in a first region of the electromagnetic spectrum having a wavelength of less than or equal to about 240 nm; (b) determining a long wavelength Reduction Equivalent Dose for the target contaminant or a challenge contaminant in a second region of the electromagnetic spectrum having a wavelength of greater than about 240 nm; and (c) summing the short wavelength Reduction Equivalent Dose and the long wavelength Reduction Equivalent Dose to produce the validated Reduction Equivalent Dose for the target contaminant. In a preferred embodiment, the present invention provides a useful approach for determining the relevant Reduction Equivalent Dose (RED) for Cryptosporidium disinfection and accomplishes this by using the discovered relation between the short wavelength sensor signal and the short wavelength RED, and subtracting the short wavelength RED from the RED determined using a challenge microbe with synthetic lamp sleeves, to obtain the long wavelength RED applicable to Cryptosporidium disinfection. In a bioassay, one would only need the short wavelength sensor reading and the challenge microbe RED using synthetic lamp sleeves to determine the applicable RED, once the relationship between the short wavelength sensor reading and the short wavelength RED was established.

### CROSS-REFERENCE TO RELATED APPLICATION

The present application claims the benefit under 35 U.S.C. §119(e) of provisional patent application Ser. No. 61/956,385, filed Jun. 7, 2013, the contents of which are hereby incorporated by reference.

### BACKGROUND OF THE INVENTION

1. Field of the Invention

2. Description of the Prior Art

Fluid treatment systems are generally known in the art. More particularly, ultraviolet (UV) radiation fluid treatment systems are generally known in the art.

Early treatment systems comprised a fully enclosed chamber design containing one or more radiation (preferably UV) lamps. Certain problems existed with these earlier designs. These problems were manifested particularly when applied to large open flow treatment systems which are typical of larger scale municipal waste water or potable water treatment plants. Thus, these types of reactors had associated with them the following problems:
relatively high capital cost of reactor;
difficult accessibility to submerged reactor and/or wetted equipment (lamps, sleeve cleaners, etc.);
difficulties associated with removal of fouling materials from fluid treatment equipment;
relatively low fluid disinfection efficiency, and/or
full redundancy of equipment was required for maintenance of wetted components (sleeves, lamps and the like).

The shortcomings in conventional closed reactors led to the development of the so-called “open channel” reactors.

For example, U.S. Pat. Nos. 4,482,809, 4,872,980 and 5,006,244 (all in the name of Maarschalkerweerd and all assigned to the assignee of the present invention and hereinafter referred to as the Maarschalkerweerd #1 patents) all describe gravity fed fluid treatment systems which employ ultraviolet (UV) radiation.

Such systems include an array of UV lamp modules (e.g., frames) which include several UV lamps each of which are mounted within sleeves which extend between and are supported by a pair of legs which are attached to a cross-piece. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the flow rate of the fluid past the lamps. Typically, one or more UV sensors may be employed to monitor the UV output of the lamps and the fluid level is typically controlled, to some extent, downstream of the treatment device by means of level gates or the like.

Also known in the art are the so-called “semi-enclosed” fluid treatment systems. U.S. Pat. Nos. 5,418,370, 5,539,210 and Re36,896 (all in the name of Maarschalkerweerd and all assigned to the assignee of the present invention and hereinafter referred to as the Maarschalkerweerd #2 patents) all describe an improved radiation source module for use in gravity fed fluid treatment systems which employ UV radiation. Generally, the improved radiation source module comprises a radiation source assembly (typically comprising a radiation source and a protective (e.g., quartz) sleeve) sealingly cantilevered from a support member. The support member may further comprise appropriate means to secure the radiation source module in the gravity fed fluid treatment system.

Historically, the fluid treatment modules and systems described in the Maarschalkerweerd #1 and #2 patents have found widespread application in the field of municipal waste water treatment (i.e., treatment of water that is discharged to a river, pond, lake or other such receiving stream).

In the field of municipal drinking water, it is known to utilize so-called “closed” fluid treatment systems or “pressurized” fluid treatment systems.

Closed fluid treatment devices are known—see, for example, U.S. Pat. No. 5,504,335 (Maarschalkerweerd #3). Maarschalkerweerd #3 teaches a closed fluid treatment device comprising a housing for receiving a flow of fluid. The housing comprises a fluid inlet, a fluid outlet, a fluid treatment zone disposed between the fluid inlet and the fluid outlet, and at least one radiation source module disposed in the fluid treatment zone. The fluid inlet, the fluid outlet and the fluid treatment zone are in a collinear relationship with respect to one another. The at least one radiation source module comprises a radiation source sealably connected to a leg which is sealably mounted to the housing. The radiation source is disposed substantially parallel to the flow of fluid. The radiation source module is removable through an aperture provided in the housing intermediate to fluid inlet and the fluid outlet thereby obviating the need to physically remove the device for service of the radiation source.

U.S. Pat. No. 6,500,346 [Taghipour et al. (Taghipour)] also teaches a closed fluid treatment device, particularly useful for ultraviolet radiation treatment of fluids such as water. The device comprises a housing for receiving a flow of fluid. The housing has a fluid inlet, a fluid outlet, a fluid treatment zone disposed between the fluid inlet and the fluid outlet and at least one radiation source having a longitudinal axis disposed in the fluid treatment zone substantially transverse to a direction of the flow of fluid through the housing. The fluid inlet, the fluid outlet and the fluid treatment zone are arranged substantially collinearly with respect to one another. The fluid inlet has a first opening having: (i) a cross-sectional area less than a cross-sectional area of the fluid treatment zone, and (ii) a largest diameter substantially parallel to the longitudinal axis of the at least one radiation source assembly.

Microorganisms are inactivated by UV light as a result of damage to nucleic acids. The high energy associated with short wavelength UV energy, primarily at 254 nm, is absorbed by cellular RNA and DNA. This absorption of UV energy forms new bonds between adjacent nucleotides, creating double bonds or dimers. Dimerization of adjacent nucleotides, particularly thymine, is the most common photochemical damage. Formation of numerous thymine dimers in the DNA of bacteria and viruses prevents replication and their ability to infect.

The germicidal effects of UV are directly related to the dose of UV energy absorbed by a microorganism. The UV dose is the product of the UV intensity and the time that a microorganism is exposed to UV light (often referred to as residence time).

The required disinfection limit or log-reduction will dictate the required UV dose. UV dose is typically expressed in mJ/cm², J/m² or μWs/cm². The exposure time of the UV system is determined by the reactor design and the flow rate of the water. The intensity is affected by the equipment parameters (such as lamp type, lamp arrangement, etc.) and water quality parameters (such as UV transmittance, TSS, etc.). Unlike chemical disinfectants, UV disinfection is not affected by the temperature, turbidity or pH of the water.

Taking all the different equipment and water quality parameters in account, the calculations of the delivered dose is complex. Theoretical models, including CFD and/or Point Source Summation dose calculations, can be susceptible to inaccuracy caused by invalid input parameters and simplification of physical phenomena. To verify the dose of the UV system for a given flow rate and water quality, carefully controlled bioassay validation must be conducted to capture the effects of all variables that can affect the delivered dose, such as hydraulics, reactor mixing, quartz sleeve transmission, etc.

The UV dose response of a microorganism is a measurement of its sensitivity to UV light and is unique to each microorganism. A UV dose response curve is determined by irradiating water samples containing the microorganism with various discrete UV doses and measuring the concentration of viable infectious micro-organisms before and after exposure. The resultant dose response curve is a plot of the log inactivation of the organism versus the applied UV dose rate. 1-log inactivation corresponds to a 90% reduction; 2-log to a 99% reduction; 3-log to a 99.9% reduction and so on.

Both the DVGW and the USEPA have published comparable inactivation doses of different water borne pathogens as per Table 1. These doses must be validated by independent bioassays for each different UV unit at different operating conditions.

TABLE 1
Data summarized from the USEPA Workshop on UV Disinfection
of Drinking Water, Apr. 28-29, 1999

| | Average UV Dose (mJ/cm²) Required to Inactivate | | | |
|---|---|---|---|---|
| Pathogen | 1-log | 2-log | 3-log | 4-log |
| Cryptosporidium parvum oocysts | 3.0 | 4.9 | 6.4 | 10 |
| Giardia lamblia cysts | NA | <5 | <10 | <10 |
| Giardia muris cysts | 1.2 | 4.7 | NA | NA |
| Vibrio cholerae | 0.8 | 1.4 | 2.2 | 2.9 |
| Escherichia coli O157:H7 | 1.5 | 2.8 | 4.1 | 5.6 |
| Salmonella typhi | 1.8-2.7 | 4.1-4.8 | 5.5-6.4 | 7.1-8.2 |
| Salmonella enteritidis | 5 | 7 | 9 | 10 |
| Legionella pneumophila | 3.1 | 5 | 6.9 | 9.4 |
| Hepatitis A virus | 4.1-5.5 | 8.2-14 | 12-22 | 16-30 |
| Poliovirus Type 1 | 4-6 | 8.7-14 | 14-23 | 21-30 |
| Rotavirus SA11 | 7.1-9.1 | 15-19 | 23-26 | 31-36 |

Bioassay validation of an actual UV water treatment system results in a Reduction Equivalent Dose (RED). If the RED for a UV system is 40 mJ/cm², it means that the UV system is delivering the same degree of inactivation as determined by the dose response curve where the test organisms were exposed to a dose of 40 mJ/cm². In a bioassay validation test procedure, it is not particularly relevant how the UV unit has been designed, how many lamps are installed or how much power the system consumes—the measured microbiological log reduction determines the efficacy of the system in relation to operational conditions.

Calculated doses from Point Source Summation method or with CFD modelling of idealized reactor configurations can predict much higher UV doses than than the doses observed in actual practice. This is the main reason that bioassay validation is important in water disinfection applications.

Step 1 in the validation exercise is determination of a UV dose response curve of a challenge microbe. Using a Collimated Beam, the microbial inactivation based on various UV doses can be plotted. This is the Dose Response Curve for the challenge organism.

Step 2 in the validation exercise is reactor evaluation and validation. Thus, the UV reactor is operated under various conditions (e.g., different UV transmittances, different lamp outputs, fluid flow rates etc.) with the same challenge organism to determine the microbial inactivation. By comparing the microbial inactivation by the reactor against the Dose Response Curve established by the Collimated Beam test, the dose delivered (RED) by the reactor can be accurately determined and validated for various operational conditions.

The test, which is referred to as bioassay validation, is conventionally executed and administrated by an independent and recognized third party at a dedicated test facility.

Based on the results of the bioassay validation exercise, a single sensor system is conventionally utilized to monitor dose at the site of the water treatment plant. The operation of that single sensor system is correlated to the results of the bioassay validation exercise. Thus, any shortcomings in the bioassay validation exercise will be translated to the single sensor system used in the commercial reactor.

A problem associated with reliance on the conventional bioassay validation procedure described above is the inaccuracy in determining the RED for Cryptosporidium disinfection when using polychromatic medium pressure mercury lamps. More generally, conventional bioassay validation is subject to the difference in the response of challenge microbes to UV radiation, as opposed to the response of the actual pathogenic organism that is to be treated. If these organisms do not respond in the same manner at all the wavelengths emitted by a polychromatic UV light source, then inaccuracies in the RED values for inactivation of the pathogen can result when conducting bioassay validations with challenge organisms.

Another problem associated relates to the prior art approach discarding the actual short wavelength contribution of the UV radiation to Cryptosporidium disinfection, for example, through the use of doped protective sleeves for the UV source.

Yet another problem is that current systems fail to adequately account for a situation where nitrate ion is present in the water and/or solarisation of the protective sleeve occurs thereby significantly reducing the amount of short wavelength radiation being transmitted to the fluid being treating.—i.e., leading to an underdosing of the fluid being treated.

Yet another problem is the “blindness” of conventional long wavelength sensors to the short wavelength UV produced by medium pressure mercury lamps.

A further problem in the art the current lack of flexibility in treatment options for pathogens or contaminants that respond to different regions of the electromagnetic spectrum.

It would be highly desirable to have a solution to at least one and preferably all of these problems of the prior art.

### SUMMARY OF THE INVENTION

It is an object of the present invention to obviate or mitigate at least one of the above-mentioned disadvantages of the prior art.

It is another object of the present invention to provide a novel process for determining a validated Reduction Equivalent Dose for reducing the concentration of a target contaminant contained in a fluid in a radiation fluid treatment system.

It is yet another object of the present invention to provide a novel process for maintaining a prescribed dose of radiation in a fluid treatment system.

It is yet another object of the present invention to provide a novel system for maintaining a prescribed dose of radiation in a fluid treatment system.

Accordingly, in one of its aspects, the present invention provides a process for determining a validated Reduction Equivalent Dose for reducing the concentration of a target contaminant contained in a fluid in a radiation fluid treatment system, the process comprising the steps of:

(a) determining a short wavelength Reduction Equivalent Dose for the target contaminant or a challenge contaminant in a first region of the electromagnetic spectrum having a wavelength of less than or equal to about 240 nm;

(b) determining a long wavelength Reduction Equivalent Dose for the target contaminant or a challenge contaminant in a second region of the electromagnetic spectrum having a wavelength of greater than about 240 nm; and

(c) summing the short wavelength Reduction Equivalent Dose and the long wavelength Reduction Equivalent Dose to produce the validated Reduction Equivalent Dose for the target contaminant.

In another of its aspects, the present invention provides a process for maintaining a prescribed dose of radiation in a fluid treatment system comprising (i) a flow of fluid comprising a target contaminant, and (ii) at least one polychromatic radiation source configured to expose the target contaminant to radiation, the process comprising the steps of:

(a) determining an actual Reduction Equivalent Dose of radiation to which the target contaminant is exposed;

(b) comparing the actual Reduction Equivalent Dose of radiation to a validated Reduction Equivalent Dose obtained according to the process described herein; and

(c) adjusting output of the at least one polychromatic radiation source to substantially compensate for any difference between the actual Reduction Equivalent Dose of radiation and the validated Reduction Equivalent Dose.

In yet another of its aspects, the present invention provides a system for maintaining a prescribed dose of radiation in a fluid treatment system comprising: (i) a flow of fluid comprising a target contaminant, and (ii) at least one polychromatic radiation source configured to expose the target contaminant to radiation, the system comprising:

(a) a first sensor configured to sense a peak radiation intensity (preferably only) in a first region of the electromagnetic spectrum having a wavelength of less than or equal to about 240 nm to produce a first measured intensity;

(a) a second sensor configured to sense a peak radiation intensity (preferably only) in a second region of the electromagnetic spectrum having a wavelength of greater than about 240 nm to produce a second measured intensity;

(b) a controller element configured to:
compare an actual Reduction Equivalent Dose to a validated Reduction Equivalent Dose obtained according to the process described herein; and
adjust the output of the at least one polychromatic radiation source to substantially compensate for any difference between the actual Reduction Equivalent Dose of radiation and the validated Reduction Equivalent Dose.

Throughout this specification, reference is made to the terms Reduction Equivalent Dose and RED. These terms are intended to have the same meaning and are used interchangeably.

The term “target contaminant” as used throughout this specification is intended to have a broad meaning and encompass any microorganism and/or chemical compound that could be regarded as: (i) a contaminant in fluid (e.g., water), or (ii) negatively affecting the performance of the fluid treatment system in question.

A number of problems in prior art are addressed by and a number of advantages accrue from the present invention.

One problem addressed by the present invention is the inaccuracy in determining the RED for, as an example, Cryptosporidium disinfection when using polychromatic medium pressure mercury lamps. Previously, it was assumed that the RED determined using a surrogate challenge microbe such as bacteriophage MS2 was applicable to Cryptosporidium disinfection. It has been discovered that the action of bacteriophage MS2 is significantly greater than Cryptosporidium at wavelengths <240 nm; these initial RED values are now known to be greater than the actual RED applicable to Cryptosporidium disinfection. This could result in under dosing of water and could be a possible risk to public health. It has also been recognized that a variety of factors such as water transparency as a function of wavelength (and therefore the nature of the UV absorber at a particular water treatment site), changes in lamp sleeve transparency at low wavelengths (due to fouling, sleeve type, solarization) and lamp power level; can all affect the relative amount of short and long wavelength UV delivered by a medium pressure mercury lamp. This in turn will change the short and long wavelength contributions to the RED determined using a challenge microbe such as bacteriophage MS2, causing variability in bioassay results.

The present invention provides a useful approach for determining the relevant RED for Cryptosporidium disinfection and accomplishes this by using the discovered relation between the short wavelength sensor signal and the short wavelength RED, and subtracting the short wavelength RED from the RED determined using a challenge microbe with synthetic lamp sleeves, to obtain the long wavelength RED applicable to Cryptosporidium disinfection. In a bioassay, one would only need the short wavelength sensor reading and the challenge microbe RED using synthetic lamp sleeves to determine the applicable RED, once the relationship between the short wavelength sensor reading and the short wavelength RED was established.

Another problem addressed by the present invention is the discarding of the actual short wavelength contribution to Cryptosporidium disinfection. It has been proposed that this could be overcome by using doped sleeves in a bioassay to eliminate the short wavelength contribution to the RED, and therefore obtain the accurate RED value. While providing similar solution to the problem addressed above, the actual short wavelength contribution to Cryptosporidium disinfection is discarded. The improvement afforded by the present invention for determining Cryptosporidium RED allows for the inclusion of the actual short wavelength contribution and, in a preferred embodiment, the use of a short wavelength sensor at the water treatment site allowing for the determination of the total actual RED for Cryptosporidium at the water treatment plant. If an event such as the presence of nitrate ion or solarization of a lamp sleeve were to occur at site, the short wavelength sensor would detect the loss of short wavelength RED and the system would then compensate for the loss in total useful RED. FIG. 10 shows the transmission spectra for new and aged synthetic sleeves, showing that prolonged exposure to UV radiation has reduced the UV transmission of the sleeves to almost half the original value for the aged sleeves. This solarization will significantly reduce the amount of short wavelength radiation being transmitted to the treatment fluid.

Another problem addressed by the present invention is the “blindness” of conventional long wavelength sensors to the short wavelength UV produced by medium pressure mercury lamps. Prior art water treatment systems use “germicidal” UV sensors with a typical wavelength response in the range of from about 240 to about 290 nm. Emission at wavelengths <240 nm can be very important for disinfection of pathogens such as adenovirus, and for the destruction of chemical contaminants such as atrazine and N-Nitrosodimethylamine (NDMA). Events such as the presence of UV absorbers such as nitrate ion or severely solarized lamp sleeves, can significantly reduce the amount of short wavelength UV produced, and conventional sensors will not detect this loss. Prior to the present invention, the inventors believe there was no efficient way of detecting the actual short wavelength UV produced and using this detection to effectively maintain the desired level of disinfection or contaminant reduction. The present invention determines the relevant contributions from different regions of the electromagnetic spectrum and combines them to determine the total relevant contribution to either disinfection or Environmental Contaminant Treatment (ECT).

A further problem addressed by the present invention is the current lack of flexibility in treatment options for pathogens or contaminants that respond to different regions of the electromagnetic spectrum. For example, in the treatment of a pathogen such as adenovirus, the use of short wavelength UV sources such as KrCl excimer lamps can be highly advantageous under conditions of high fluid transparency, since the transmission of low wavelength radiation will be high under these conditions and the disinfection action of adenovirus at low wavelength is high. When the fluid transparency at short wavelengths is reduced, which is frequently the case when UV absorbers are present, longer wavelength UV may be more effective. In a preferred embodiment, the present invention provides a process to determine which light source, either main or auxiliary lamps, would be most economical for treatment under given operating conditions. The treatment system can now respond flexibly to changing conditions to maximize treatment and minimize power costs.

Other advantages of the present invention will be apparent to those of skill in the art having in hand the present specification.

### BRIEF DESCRIPTION OF THE DRAWINGS

Embodiments of the present invention will be described with reference to the accompanying drawings, wherein like reference numerals denote like parts, and in which:

FIGS. 1-10 illustrate preferred aspects and embodiments of the present invention.

### DETAILED DESCRIPTION OF THE PREFERRED EMBODIMENTS

The present invention relates to a process for determining a validated Reduction Equivalent Dose for reducing the concentration of a target contaminant contained in a fluid in a radiation fluid treatment system, the process comprising the steps of: (a) determining a short wavelength Reduction Equivalent Dose for the target contaminant or a challenge contaminant in a first region of the electromagnetic spectrum having a wavelength of less than or equal to about 240 nm; (b) determining a long wavelength Reduction Equivalent Dose for the target contaminant or a challenge contaminant in a second region of the electromagnetic spectrum having a wavelength of greater than about 240 nm; and (c) summing the short wavelength Reduction Equivalent Dose and the long wavelength Reduction Equivalent Dose to produce the validated Reduction Equivalent Dose for the target contaminant. Preferred embodiments of this process may include any one or a combination of any two or more of any of the following features:
the first region of the electromagnetic spectrum has a wavelength in the range of from about 200 nm to about 240 nm;
the second region of the electromagnetic spectrum has a wavelength in the range of from greater than about 240 nm to about 300 nm;
the target contaminant is a chemical compound characterized in undergoing photolysis (with or without a catalyst) when exposed to radiation having at least one wavelength in at least one of the first region of the electromagnetic spectrum and the second region of the electromagnetic spectrum;
the target contaminant is a peroxide compound;
the target contaminant is selected from the group consisting atrazine, trichloroethylene, hydrogen peroxide, a dissolved nitrate iontaste and odor-causing compounds (e.g., geosmin and MIB), N-nitrosodimethylamine (NDMA), pharmaceuticals and personal care products (PPCPs), pesticides, herbicides, 1,4-dioxane, fuels and fuel additives (e.g., MTBE and BTEX), VOC's (e.g., PCE and TCE), endocrine disruptor chemicals (EDC's), algal toxins (e.g., microcystin) and any mixture of two or more of these;
the target contaminant is N-nitrosodimethylamine;
the target contaminant is hydrogen peroxide;
the target contaminant is a microorganism;
the target contaminant is a bacteria;
the target contaminant is a virus;
the target contaminant is a selected from the group consisting of Cryptosporidium parvum oocysts, Giardia lamblia cysts, Giardia muris cysts, Vibrio cholera, Escherichia coli O157:H7, Salmonella typhi, Salmonella enteritidis, Legionella pneumophila, Hepatitis A virus, Poliovirus Type 1, Rotavirus SA11, Adenovirus and any combination thereof;
the target contaminant is a bacterial species from the genus Cryptosporidium;
the target contaminant is a bacterial species from the genus Giardia;
the target contaminant is an Escherichia coli;
the target contaminant is a virus;
Step (a) comprises determining a short wavelength Reduction Equivalent Dose for achieving at least a 2 log reduction in the concentration of the target contaminant in the fluid;
Step (a) comprises determining a short wavelength Reduction Equivalent Dose for achieving at least a 3 log reduction in the concentration of the target contaminant in the fluid;
Step (a) comprises determining a short wavelength Reduction Equivalent Dose for achieving at least a 4 log reduction in the concentration of the target contaminant in the fluid;
Step (b) comprises determining a long wavelength Reduction Equivalent Dose for achieving at least a 2 log reduction in the concentration of the target contaminant in the fluid;
Step (b) comprises determining a long wavelength Reduction Equivalent Dose for achieving at least a 3 log reduction in the concentration of the target contaminant in the fluid;
Step (b) comprises determining a long wavelength Reduction Equivalent Dose for achieving at least a 4 log reduction in the concentration of the target contaminant in the fluid;
Step (a) comprising determining a short wavelength Reduction Equivalent Dose for the target contaminant in a first region of the electromagnetic spectrum having a wavelength of less than or equal to about 240 nm;
Step (a) comprises determining a short wavelength Reduction Equivalent Dose for the target contaminant in the first region of the electromagnetic spectrum;
Step (b) comprises determining a long wavelength Reduction Equivalent Dose for the target contaminant in the second region of the electromagnetic spectrum;
Step (a) comprises determining a short wavelength Reduction Equivalent Dose for a challenge contaminant in the first region of the electromagnetic spectrum;
Step (b) comprises determining a long wavelength Reduction Equivalent Dose for a challenge contaminant in the second region of the electromagnetic spectrum;
the challenge contaminant is a microorganism;
the challenge contaminant is selected from the group consisting of bacteriophage MS2, T2, Φx174, B. subtilis, E. coli, B40-8, PRD-1, Qβ, T1, T1UV, T7, T7m, A. niger (now known as A. brasiliensis) and B. pumilus;
the challenge contaminant is bacteriophage MS2;
Step (a) comprises: exposing a sample of fluid containing a prescribed concentration of the target contaminant or the challenge contaminant to radiation; measuring the intensity of the radiation using a first sensor configured to sense a peak radiation intensity in the first region of the electromagnetic spectrum to produce a first measured intensity; and calculating the short wavelength Reduction Equivalent Dose from the first measured intensity;
the first sensor comprises a first sensor element and a first filter element configured to substantially block radiation outside the first region of the electromagnetic spectrum from impinging on the first sensor element;
the first sensor element comprises a silicon-containing material (e.g., silicon carbide);
Step (b) comprises: exposing a sample of fluid containing a prescribed concentration of the target contaminant or the challenge contaminant to radiation; measuring the intensity of the radiation using a second sensor configured to sense a peak radiation intensity in the second region of the electromagnetic spectrum to produce a second measured intensity; and calculating the long wavelength Reduction Equivalent Dose from the second measured intensity;
the second sensor comprises a second sensor element and a second filter element configured to substantially block radiation outside the second region of the electromagnetic spectrum from impinging on the second sensor element; and/or
the second sensor element comprises a silicon-containing material (e.g., silicon carbide).

The present invention further relates to a process for maintaining a prescribed dose of radiation in a fluid treatment system comprising (i) a flow of fluid comprising a target contaminant, and (ii) at least one polychromatic radiation source configured to expose the target contaminant to radiation, the process comprising the steps of: determining an actual Reduction Equivalent Dose of radiation to which the target contaminant is exposed; comparing the actual Reduction Equivalent Dose of radiation to a validated Reduction Equivalent Dose obtained according to the process described herein; and adjusting output of the at least one polychromatic radiation source to substantially compensate for any difference between the actual Reduction Equivalent Dose of radiation and the validated Reduction Equivalent Dose. Preferred embodiments of this process may include any one or a combination of any two or more of any of the following features:
the at least one polychromatic radiation source is an ultraviolet radiation source;
the at least one polychromatic radiation source is a medium pressure ultraviolet radiation source;
the target contaminant is a chemical compound characterized in undergoing photolysis (with or without a catalyst) when exposed to radiation having at least one wavelength in at least one of the first region of the electromagnetic spectrum and the second region of the electromagnetic spectrum;
the target contaminant is a peroxide compound;
the target contaminant is selected from the group consisting atrazine, trichloroethylene, hydrogen peroxide, a dissolved nitrate iontaste and odor-causing compounds (e.g., geosmin and MIB), N-nitrosodimethylamine (NDMA), pharmaceuticals and personal care products (PPCPs), pesticides, herbicides, 1,4-dioxane, fuels and fuel additives (e.g., MTBE and BTEX), VOC's (e.g., PCE and TCE), endocrine disruptor chemicals (EDC's), algal toxins (e.g., microcystin) and any mixture of two or more of these;
the target contaminant is N-nitrosodimethylamine;
the target contaminant is hydrogen peroxide;
the target contaminant is a microorganism;
the target contaminant is a bacteria;
the target contaminant is a virus;
the target contaminant is a selected from the group consisting of Cryptosporidium parvum oocysts, Giardia lamblia cysts, Giardia muris cysts, Vibrio cholera, Escherichia coli O157:H7, Salmonella typhi, Salmonella enteritidis, Legionella pneumophila, Hepatitis A virus, Poliovirus Type 1, Rotavirus SA11 and any combination thereof;
the target contaminant is a bacterial species from the genus Cryptosporidium;
the target contaminant is a bacterial species from the genus Giardia;
the target contaminant is an Escherichia coli;
the target contaminant is a virus;
Step (a) comprises: determining an actual short wavelength Reduction Equivalent Dose; determining an actual long wavelength Reduction Equivalent Dose; and summing the actual short wavelength Reduction Equivalent Dose and the actual long wavelength Reduction Equivalent Dose to produce the actual Reduction Equivalent Dose;
the actual short wavelength Reduction Equivalent Dose is determined by: (i) measuring a first intensity of radiation to which the target organism is exposed using a first sensor configured to sense a peak radiation intensity (preferably only) in a first region of the electromagnetic spectrum having a wavelength of less than or equal to about 240 nm to produce a first measured intensity; and (ii) calculating the actual short wavelength Reduction Equivalent Dose from the first measured insensity;
the first sensor comprises a first sensor element and a first filter element configured to substantially block radiation outside the first region of the electromagnetic spectrum from impinging on the first sensor element;
the first sensor element comprises a silicon-containing material (e.g., silicon carbide);
the actual long wavelength Reduction Equivalent Dose is determined by: (i) measuring a second intensity of radiation to which the target organism is exposed using a second sensor configured to sense a peak radiation intensity (preferably only) in a first region of the electromagnetic spectrum having a wavelength of greater than about 240 nm to produce a second measured intensity; and (ii) calculating the actual long wavelength Reduction Equivalent Dose from the second measured insensity;
the second sensor comprises a second sensor element and a second filter element configured to substantially block radiation outside the second region of the electromagnetic spectrum from impinging on the second sensor element; and/or
the second sensor element comprises a silicon-containing material (e.g., silicon carbide)

The present invention further relates to a system for maintaining a prescribed dose of radiation in a fluid treatment system comprising: (i) a flow of fluid comprising a target contaminant, and (ii) at least one polychromatic radiation source configured to expose the target contaminant to radiation, the system comprising: a first sensor configured to sense a peak radiation intensity (preferably only) in a first region of the electromagnetic spectrum having a wavelength of less than or equal to about 240 nm to produce a first measured intensity; a second sensor configured to sense a peak radiation intensity (preferably only) in a first region of the electromagnetic spectrum having a wavelength of greater than about 240 nm to produce a second measured intensity; and a controller to element configured to: compare an actual Reduction Equivalent Dose to a validated Reduction Equivalent Dose obtained according to the process defined in Claims 1-36; and adjust the output of the at least one polychromatic radiation source to substantially compensate for any difference between the actual Reduction Equivalent Dose of radiation and the validated Reduction Equivalent Dose. Preferred embodiments of this system process may include any one or a combination of any two or more of any of the following features:
the controller element is configured to: calculate an actual short wavelength Reduction Equivalent Dose from the first measured intensity; calculate an actual long wavelength Reduction Equivalent Dose from the second measured intensity; sum the actual short wavelength Reduction Equivalent Dose and the actual short wavelength Reduction Equivalent Dose to produce an actual Reduction Equivalent Dose; compare the actual Reduction Equivalent Dose to a validated Reduction Equivalent Dose obtained according to the process described herein; and adjust the output of the at least one polychromatic radiation source to substantially compensate for any difference between the actual Reduction Equivalent Dose of radiation and the validated Reduction Equivalent Dose;
the first sensor comprises a first sensor element and a first filter element configured to substantially block radiation outside the first region of the electromagnetic spectrum from impinging on the first sensor element;
the first sensor element comprises a silicon-containing material (e.g., silicon carbide);
the second sensor comprises a second sensor element and a second filter element configured to substantially block radiation outside the second region of the electromagnetic spectrum from impinging on the second sensor element;
the second sensor element comprises a silicon-containing material (e.g., silicon carbide);
the at least one polychromatic radiation source an ultraviolet radiation source;
the at least one polychromatic radiation source a medium pressure ultraviolet radiation source;
the target contaminant is a chemical compound characterized in undergoing photolysis (with or without a catalyst) when exposed to radiation having at least one wavelength in at least one of the first region of the electromagnetic spectrum and the second region of the electromagnetic spectrum;
the target contaminant is a peroxide compound;
the target contaminant is selected from the group consisting atrazine, trichloroethylene, hydrogen peroxide, a dissolved nitrate iontaste and odor-causing compounds (e.g., geosmin and MIB), N-nitrosodimethylamine (NDMA), pharmaceuticals and personal care products (PPCPs), pesticides, herbicides, 1,4-dioxane, fuels and fuel additives (e.g., MTBE and BTEX), VOC's (e.g., PCE and TCE), endocrine disruptor chemicals (EDC's), algal toxins (e.g., microcystin) and any mixture of two or more of these;
the target contaminant is N-nitrosodimethylamine;
the target contaminant is hydrogen peroxide;
the target contaminant is a microorganism;
the target contaminant is a bacteria.
the target contaminant is a virus;
the target contaminant is a selected from the group consisting of Cryptosporidium parvum oocysts, Giardia lamblia cysts, Giardia muris cysts, Vibrio cholera, Escherichia coli O157:H7, Salmonella typhi, Salmonella enteritidis, Legionella pneumophila, Hepatitis A virus, Poliovirus Type 1, Rotavirus SA11 and any combination thereof;
the target contaminant is a bacterial species from the genus Cryptosporidium;
the target contaminant is a bacterial species from the genus Giardia;
the target contaminant is an Escherichia coli; and/or
the target contaminant is a virus.

A particularly preferred embodiment of the invention will be described with reference to a water treatment system containing medium pressure ultraviolet radiation sources for disinfection of Cryptosporidium. However, this is for illustrative purposes only and it should be understood that the present invention is application to fluid treatment systems utilizing polychromatic radiation sources for treatment of a variety of target contaminants (preferred embodiments of which are referred to herein).

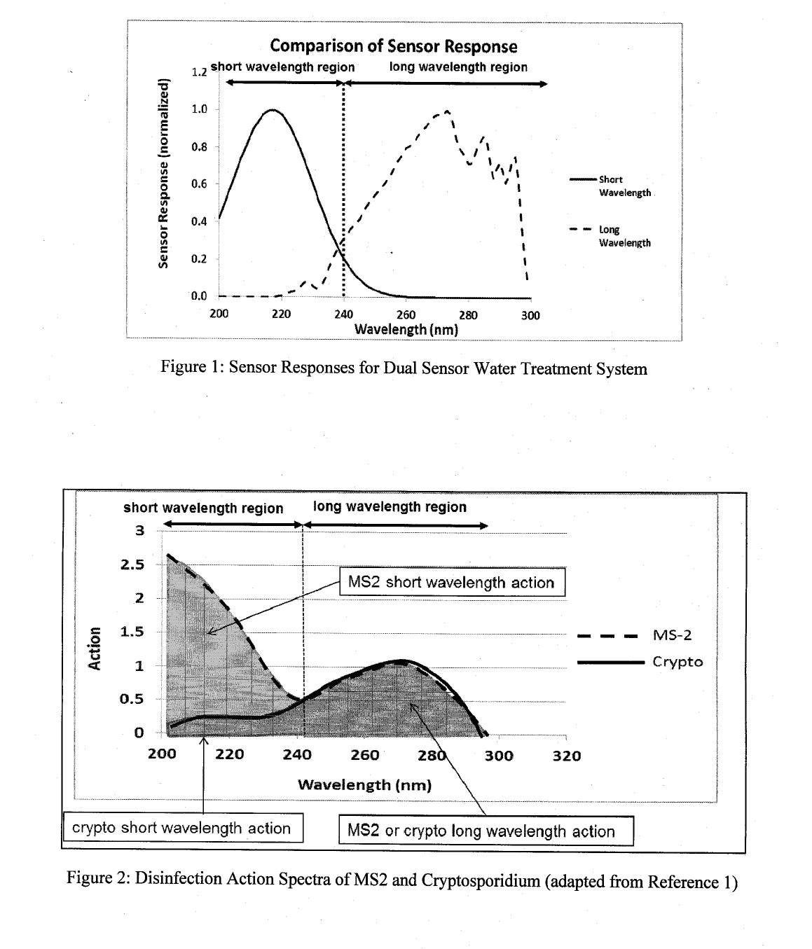

Thus, a preferred embodiment of the invention is an ultraviolet radiation water treatment system consisting of an inlet, outlet, and fluid treatment zone containing one or more (usually a plurality) polychromatic ultraviolet lamps. These lamps emit ultraviolet light at more than one wavelength and as a result, the ultraviolet treatment that takes place within the treatment zone can take place at more than one wavelength. This system will contain at least two ultraviolet sensors, one responding in one wavelength region of the electromagnetic spectrum, and the second responding in a different second region of the spectrum. FIG. 1 illustrates preferred sensor responses for a preferred embodiment of the invention used in water disinfection with polychromatic medium pressure mercury lamps and a Trojan Technologies TrojanUVSwift™ system.

With reference to FIG. 1, the normalized response for a conventional TrojanUVSwift sensor displaying “germicidal” response is denoted by the dashed line, where 80% of the cumulative sensor response lies between 246 and 291 nm. The second sensor response denoted with the solid line has 80% of its cumulative response between 205 and 235 nm. Therefore, the two sensors monitor adjacent regions of the electromagnetic spectrum where the second will be designated the short wavelength (SW) sensor, and the first will designated the long wavelength (LW) sensor.

The system preferably comprises a programmable logic device that can determine the RED for each sensor wavelength region as a function of the sensor signal, for a given reactor configuration and fluid flow rate (preferably programmed in a conventional manner with the logic and parameters referred to herein). The calculations are based on relationships between sensor signal and RED determined by either experimental bioassay results or computer simulations such as the Trojan Technologies Lagrangian particle tracking calculation software (labeled LDM), or computational fluid dynamics.

An example use and calculation are as follows.

An experimental bioassay validation was performed in a TrojanUVSwift™ 12 system using a bacteriophage MS2 challenge microbe and either doped or synthetic lamp sleeves (synthetic quartz sleeves were used but it should be appreciated that natural quartz sleeves may be used), for various reactor configurations (2L12 or 4L12), fluid flow rates, where 254 nm UVT values were achieved using adjustable concentrations of different UVT modifiers (LSA, tea and Superhume). The UVT is defined as the transmittance of a fluid at a defined wavelength, in this case 254 nm, through a thickness of 1 cm.

It was desired to determine the RED that was attributable to disinfection of Cryptosporidium, which primarily occurs in the long wavelength region of the spectrum. The challenge is that the bacteriophage MS2 challenge microbe used to determine the RED is also sensitive to the short wavelength spectral region, so that the bacteriophage MS2 RED will consist of both the desired long wavelength RED and the short wavelength RED. MS

FIG. 2 shows the action spectra of MS2 and Cryptosporidium for UV radiation in the short and long wavelength regions of the spectrum, where the division into the short and long wavelength regions and the associated short and long wavelength action illustrated. It can be seen that bacteriophage MS2 will respond to the short wavelength lamp radiation reaching the microbes as well as the long wavelength radiation, while the Cryptosporidium will respond primarily to the long wavelength radiation.

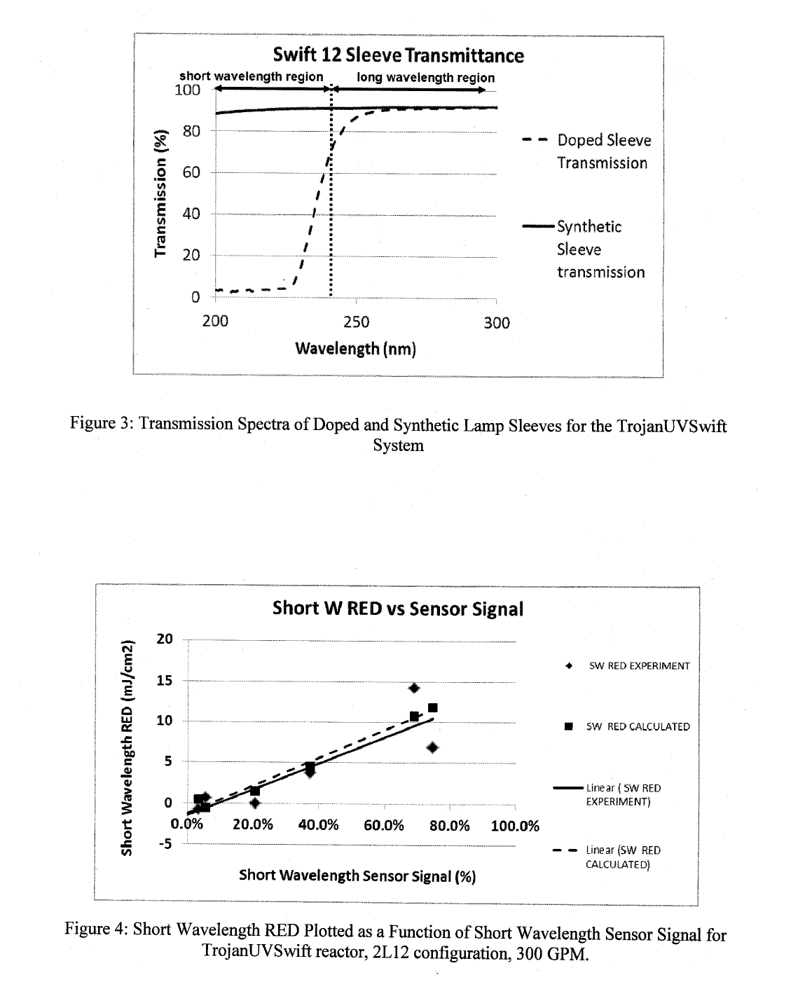

The transmission spectra of doped and synthetic TrojanUVSwift™ lamp sleeves are shown in FIG. 3, where the doped sleeves effectively block the short wavelength radiation from 200-240 nm, and the synthetic sleeves transmit both the short and long wavelength radiation.

The experimental or theoretical bioassay results obtained with bacteriophage MS2 and doped sleeves will yield the RED for the long wavelength region according to Equation [1]:

RED_{LW}=RED_{MS2,doped}, [1]

and the results for the synthetic sleeves will yield the RED for both the short and long wavelength region according to Equation [2]

RED_{SW}+RED_{LW}=RED_{MS2,synthetic}. [2]

The RED for the short wavelength region can therefore be calculated by subtracting the doped sleeve RED from the synthetic sleeve RED according to Equation [3].

RED_{SW}=RED_{MS2,synthetic}−RED_{LW}=RED_{MS2,synthetic}−RED_{MS2,doped}. [3]

The RED for the short wavelength region, calculated from the experimental bioassay results and theoretical LDM calculations for a known reactor configuration and water flow rate may then be plotted as a function of the short wavelength sensor signal. The results are shown in FIG. 4, where a linear relationship between short wavelength sensor signal and short wavelength RED calculated using theoretical LDM results is obtained. For the example shown in FIG. 4, the function would be

RED_{SW}=17.1 mJ/cm²×(SW sensor as fraction of full scale)−1.2 mJ/cm².

The same linear relationship exists for the short wavelength RED calculated using the experimental data, considering the scatter in the experimental results. These results are obtained at various 254 nm UVT values for the LSA, tea and Superhume UVT modifiers. The LDM and the corresponding short wavelength sensor data can be used to determine the short wavelength RED for other reactor configurations and flow rates. This result indicates that it is possible to predict the short wavelength contribution to the RED using the short wavelength sensor signal and a known linear relationship between RED_{SW} and the short wavelength sensor signal, for a given reactor configuration and water flow rate.

For future bioassays to a first approximation, the calculated short wavelength RED can be subtracted from the total MS2 RED obtained with synthetic sleeves to yield the long wavelength RED applicable to Cryptosporidium disinfection RED_{crypto}, making the assumption that RED_{crypto} has a long wavelength contribution only, more specifically:

RED_{crypto}˜RED_{LW}=RED_{MS2,synthetic}−RED_{SW} [from equation 2]

RED_{MS2,synthetic}−f(SW sensor), [4]

where f(SW sensor) is the linear relationship between the short wavelength sensor signal and RED_{sw} determined using a challenge microbe. Thus an advantage of the present invention is that it be used to save the expense and time of conducting doped sleeve bioassays, now that the relationship between the short wavelength sensor signal and short wavelength RED has been established.

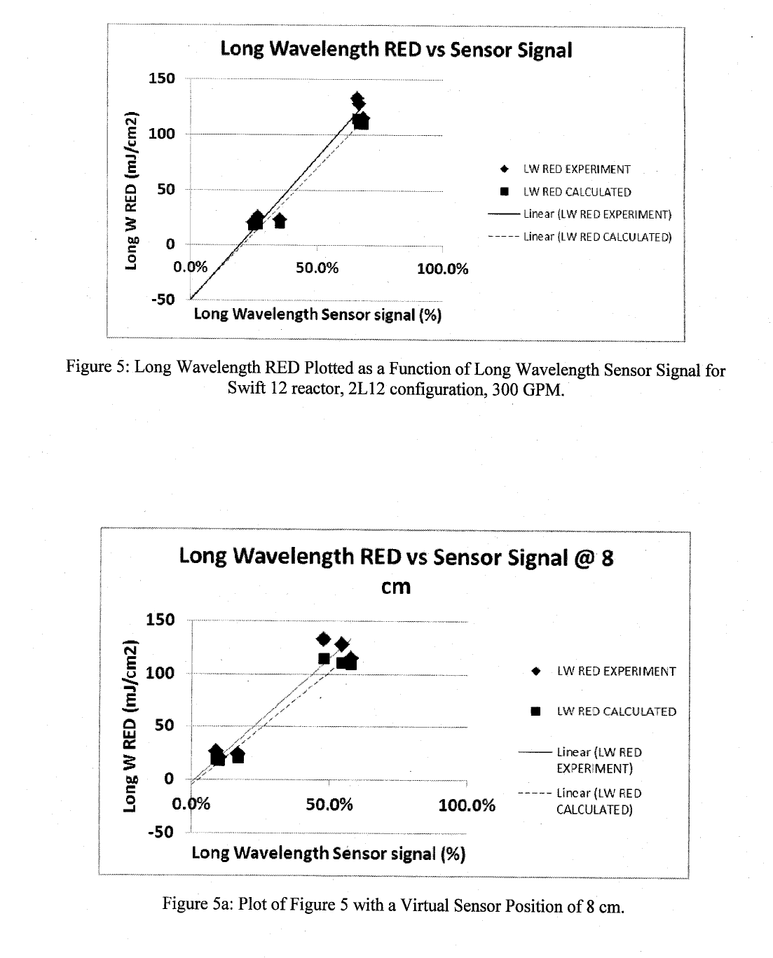

For the TrojanUVSwift™ bioassay discussed, the long wavelength RED determined using the doped sleeve bioassay is then assigned to the sensor readings obtained using the long wavelength sensor, and the minimum required RED for disinfection of Cryptosporidium can be obtained by keeping the long wavelength sensor readings at or above the values required by the validation results. A plot of the long wavelength RED as a function of the long wavelength sensor signal is shown in FIG. 5.

There is substantial agreement between the experimental bioassay and LDM data, and the linear relationships between long wavelength RED and long wavelength sensor signal are in reasonable agreement. The linear plots do not go through the origin in this case, indicating that the long wavelength sensor may not be at the optimum distance for sensor setpoint operation. Optimum placement of the sensor is demonstrated when a single linear relation exists between RED and sensor signal at fixed reactor configuration and water flow, but variable lamp power and UVT. Conversely, the short wavelength sensor does appear to be at the optimum position for sensor setpoint operation. By calculating the change expected in the long wavelength sensor signal from the position used in the bioassay to a second virtual position, the RED versus sensor signal relationship can be re-calculated. When changing from an actual sensor position of 4.4 cm to 8.0 cm, the plot shown in FIG. 5a is obtained where the linear plots now go through the origin at a virtual position of 8.0 cm.

The choice of using either experimental bioassay data or calculated values to generate the linear relationship between short wavelength RED and short wavelength sensor signal can be determined, for example, by regulatory acceptance. If it is acceptable to use a validated theoretical calculation model to determine short wavelength RED values, then the expense and effort of conducting a bioassay with doped lamp sleeves can be saved. If bioassay RED values are required for all validated data, then expense can still be saved by bracketing the desired range of low wavelength sensor readings needed with experimental results using doped and synthetic sleeves to determine low wavelength RED. Calculated low wavelength RED values for other low wavelength sensor readings within the bracketed range can then be used during the bioassay validation when only synthetic sleeves are used.

The model used to determine the RED for Cryptosporidium can be made more advanced by considering the fact that the action of Cryptosporidium is not zero at wavelengths <240 nm, as shown in FIG. 2. The most accurate expression for the RED of cryptosporidium RED_{crypto} can be expressed as:

RED_{crypto}=RED_{cryptoLW}+RED_{cryptoSW}.

Using Equation[4] to substitute for the long wavelength RED contribution, the RED_{crypto} may be calculated according to Equation[5]:

RED_{crypto}=RED_{MS2,synthetic}−f(SW sensor)+RED_{CryptoSW}. [5]

Here, the response of Cryptosporidium to short wavelength UV is added back after eliminating the MS2 contribution at short wavelength. If RED_{cryptoSW} is also a function of the short wavelength sensor signal f_{crypto} (SW sensor), then

RED_{crypto}=RED_{MS2,synthetic}−f(SW sensor)+f_{crypto}(SW sensor). [6]

Equation[6] can be used at the time of bioassay to determine the most accurate assessment of the disinfection ability of a reactor for Cryptosporidium. The two functions dependent on the short wavelength sensor reading can be combined into a single function f_{corr} such that f_{corr}=f−f_{crypto}, so that

RED_{crypto}=RED_{MS2,synthetic}−f_{corr}(SW sensor). [7]

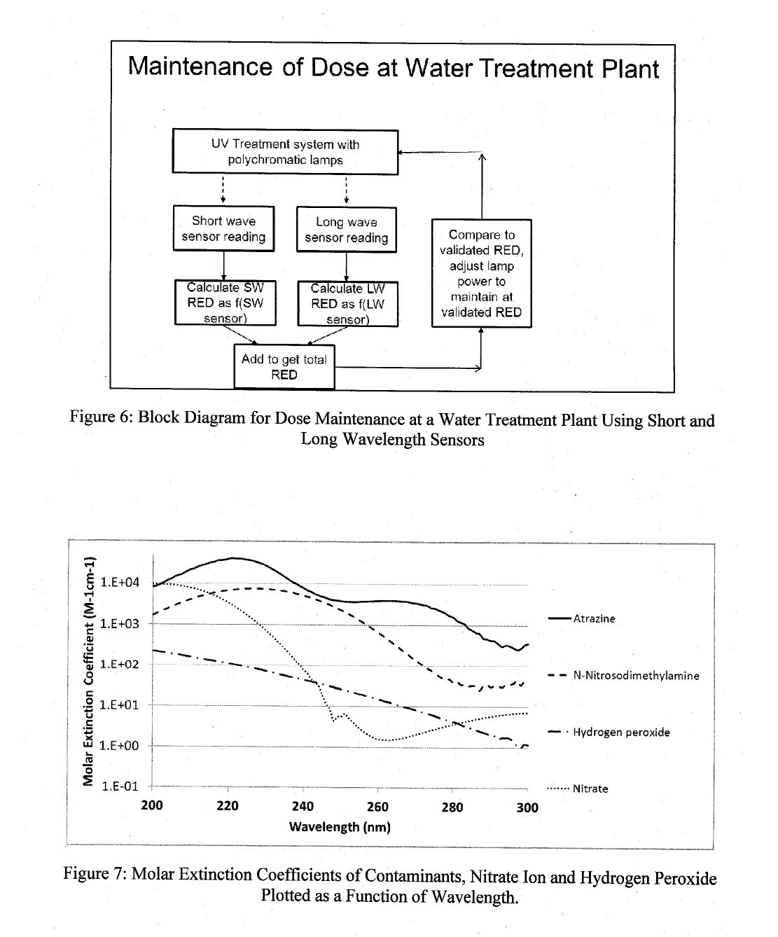

At a water treatment plant, the use of Equation[4] (e.g., programmed into a logic controller) and using long wavelength sensor data only to monitor disinfection will be conservative since all short wavelength contributions to Cryptosporidium disinfection have been discounted. The validated long wavelength RED values for Cryptosporidium would be determined using the bioassay and appropriate subtraction of the short wavelength RED, and the long wavelength sensor readings would be used to ensure that the minimum sensor readings corresponding to these validated RED values are maintained. However, there is also the option of determining the total RED for Cryptosporidium by adding the short wavelength contribution to crypto RED using the function f_{crypto} and the short wavelength sensor reading at the water treatment plant as shown in Equation[6]. In this last case, both short and long wavelength sensors will be needed at the water treatment plant, so that the short and long wavelength contributions to the total RED can be determined. A block diagram of this process is shown in FIG. 6. Allowable higher doses or reduced energy cost to maintain a fixed dose is now possible, since the low wavelength contribution to Cryptosporidium disinfection is now included.

The present invention may be used in applications other than determining the RED for Cryptosporidium disinfection. For example, if it is desired to achieve a certain RED for disinfection of adenovirus, there will be significant contributions to disinfection of this pathogen from both the short wavelength and long wavelength portions of the spectrum. The relationship between the respective RED values and sensor signals for given reactor configurations and water flow rates is determined during the validation as before, but in this case both the short wavelength RED and long wavelength RED are calculated from sensor readings at a water treatment site, and summed to give the total disinfection RED as shown in FIG. 6. This would be similar to the advanced model for Cryptosporidium treatment at a water treatment plant.

Similarly, environmental contaminant treatment (ECT) utilizes UV light to destroy harmful chemicals by either direct photolysis, or indirectly through an advanced oxidation agent such as hydrogen peroxide.

FIG. 7 shows that many chemical contaminants such as atrazine and N-nitrosodimethylamine (MDMA) that can be treated by direct photolysis, have the highest absorption at wavelengths <240 nm. This wavelength region is below the detection limit of standard long wavelength sensors, so these sensors can only be used as an indirect measure of the UV light intensity being provided at short wavelengths at best. In a challenging case, the presence of species such as dissolved nitrate ion (NO₃⁻, see FIG. 7) can absorb UV radiation in this important short wavelength region, and the loss of short wavelength UV will not be detected by standard sensors. The use of short and long wavelength sensors and the determination of the total RED will detect the loss of RED in the short wavelength region, and the total power delivered to the lamps can be increased to deliver the required dose for contaminant reduction. Similarly, advanced oxidation agents such as hydrogen peroxide rely on short wavelength UV for the maximum production of the hydroxyl radicals that destroy harmful contaminants. Use of the dual sensor system and total RED determination will ensure that the dose required for advanced oxidation will be delivered.

As a variation of above preferred embodiments of using sensors to determine RED, a fiber optic probe attached to a portable spectrometer can be used to determine the irradiance of UV light in a sensor port in a UV water treatment system. The irradiance will be determined as a function of wavelength, and sums in specific wavelength regions can be determined to get the sensor signals for these wavelength regions.

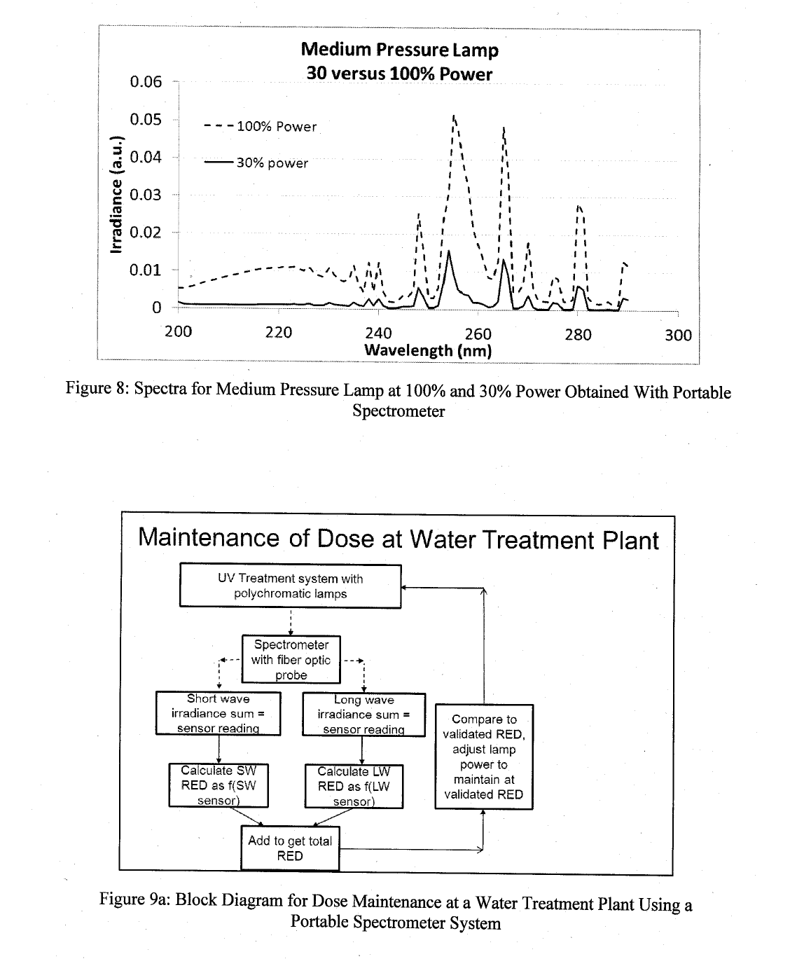

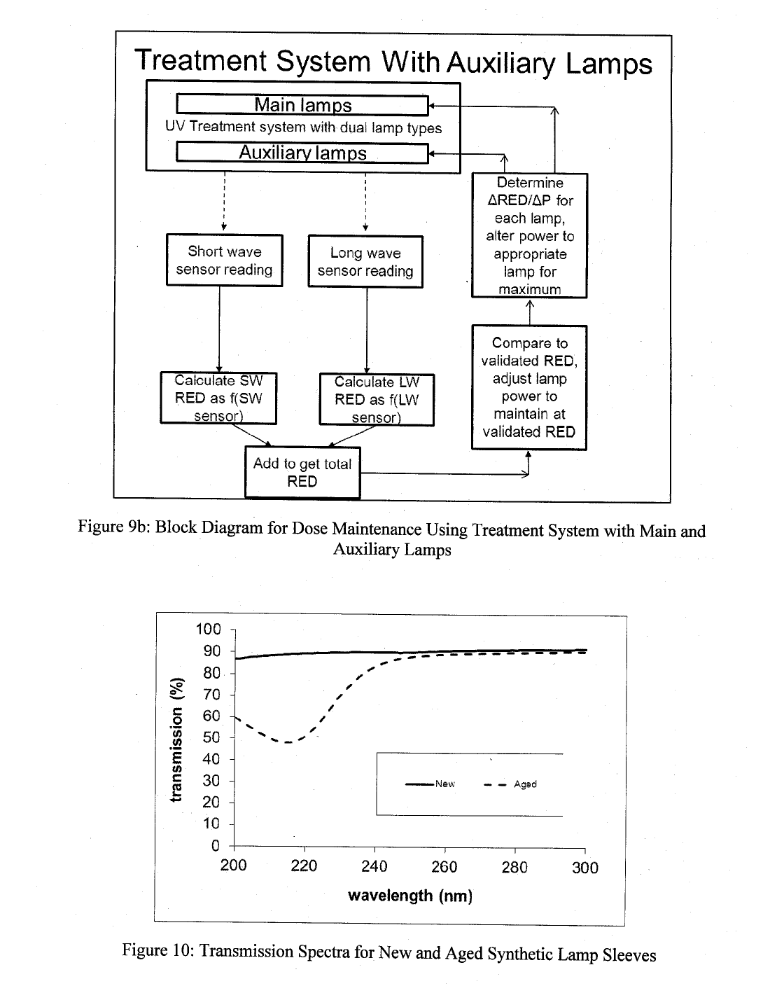

For example, irradiance sums from 200-240 and 241-290 nm can be determined using the probe and spectrometer, and these sums will be equivalent to the respective short and long wavelength sensor signals that were discussed earlier. Sample spectra for a medium pressure lamp at 100% and 30% ballast power is shown in FIG. 8, along with the calculation results for the corresponding sensor readings in Table 1.

FIG. 8 illustrates that there is a significant decrease in signal from the lamp at all wavelengths when the power is reduced to 30%. The table shows the irradiance sums that are assigned a sensor value of 100% at 100% power. When the lamp power is reduced to 30% the irradiance sums are calculated again, and the decrease in sensor signal at short wavelengths is more pronounced at 12.8% full scale, versus a decrease to 20.0% full scale at long wavelengths.

TABLE 1
Results for Sensor Readings from Lamp Spectra in FIG. 8

| Percent Lamp | Wavelength Range | Irradiance Sum | Percent Full |
|---|---|---|---|
| Power | (nm) | (a.u.) | Scale |
| 100% | 200-240 | 0.365 | 100% |
| | 241-290 | 0.635 | 100% |
| 30% | 200-240 | 0.047 | 12.8% |
| | 241-290 | 0.174 | 20.0% |

The short wavelength sums can be used in the same way to determine RED_{crypto} as shown in Equations [4] or [6] during bioassay validation, or both the short and long wavelength sums can be used to maintain the validated RED at the water treatment plant.

FIG. 9a shows a modified block diagram for maintenance of dose at a water treatment plant using a portable spectrometer. In this invention, a light pipe or other conduit for the UV radiation detected within the sensor port can be used to convey the UV radiation to the portable spectrometer. The results from the portable spectrometer can also be subdivided into irradiance sums from smaller wavelength regions, and theoretical calculations can be used to determine the expected RED from each spectral region, which would be the equivalent of having many sensors with their own wavelength regions and associated RED values. The total applicable RED for a target pathogen or chemical contaminant can be determined by summing the contributions over the relevant wavelength regions.

Another embodiment of the present invention relates to the use and control of another type of UV light source other than a polychromatic lamp in the UV treatment system. For example, an auxiliary lamp consisting of UV light emitting diodes or an excimer lamp can be used to assist a standard medium pressure mercury lamp for disinfection or ECT.

For the disinfection of adenovirus for example, which has higher action at 220 nm than at 260 nm, or removal of NDMA which has a peak absorption at ˜228 nm, a KrCl excimer lamp emitting at 222 nm could be an effective light source. The addition of the 222 nm source would be detected by the short wavelength sensor and the short wavelength RED for the system would be increased to maintain the total validated RED. The relative electrical efficiencies of the auxiliary lamp and polychromatic lamp can be considered to compute ΔRED/ΔP where P is the electrical power fed to the lamps, and the appropriate lamp is increased so that ΔRED/ΔP is maximized. In the terminology of the ECT industry, this calculation would be equivalent to the minimization of the electrical energy per order of magnitude reduction in the chemical contaminant, the EEO.

Determination of ΔRED/ΔP may be made as follows.

The desired quantity can be expressed as

ΔRED/ΔP=ΔRED/ΔS×ΔS/ΔP

where ΔS is a change in the sensor signal S. The first term on the right hand side of the equation is simply the slope of the line for the RED versus sensor signal function that has been determined for both the short wavelength and long wavelength sensors. By applying a small oscillating electrical signal to each lamp type and monitoring the corresponding oscillation in the sensor signals, the value for ΔS/ΔP can be determined for both sensor types during operation of the treatment system. Alternately, ΔS/ΔP can be pre-determined by creating a lookup table of ΔS/ΔP as a function of S for each lamp at validation time, and the appropriate value for ΔS/ΔP during operation of the system can be known using the sensor signal value as an input.

It is also possible that the auxiliary lamp can be used with low pressure mercury lamps emitting at 254 nm as the primary lamp source, so the total system is still polychromatic and the short and long wavelength sensors would sense the auxiliary and low pressure mercury lamps respectively. A block diagram for control of a water treatment system using two different lamp types is shown in FIG. 9b.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A process for determining a validated Reduction Equivalent Dose for reducing the concentration of a target contaminant contained in a fluid in a radiation fluid treatment system, the process comprising the steps of:
(a) determining a short wavelength Reduction Equivalent Dose for the target contaminant or a challenge contaminant in a first region of the electromagnetic spectrum having a wavelength of less than or equal to about 240 nm;
(b) determining a long wavelength Reduction Equivalent Dose for the target contaminant or a challenge contaminant in a second region of the electromagnetic spectrum having a wavelength of greater than about 240 nm; and
(c) summing the short wavelength Reduction Equivalent Dose and the long wavelength Reduction Equivalent Dose to produce the validated Reduction Equivalent Dose for the target contaminant.

2. The process defined in claim 1, wherein the first region of the electromagnetic spectrum has a wavelength in the range of from about 200 nm to about 240 nm.

3. (canceled)

4. The process defined in claim 1, wherein the target contaminant is a chemical compound characterized in undergoing photolysis (with or without a catalyst) when exposed to radiation having at least one wavelength in at least one of the first region of the electromagnetic spectrum and the second region of the electromagnetic spectrum.

5-8. (canceled)

9. The process defined in claim 1, wherein the target contaminant is a microorganism.

10-16. (canceled)

17. The process defined in claim 9, wherein Step (a) comprises determining a short wavelength Reduction Equivalent Dose for achieving at least a 2 log reduction in the concentration of the target contaminant in the fluid.

18-19. (canceled)

20. The process defined in claim 9, wherein Step (b) comprises determining a long wavelength Reduction Equivalent Dose for achieving at least a 2 log reduction in the concentration of the target contaminant in the fluid.

21-22. (canceled)

23. The process defined in claim 1, wherein Step (a) comprising determining a short wavelength Reduction Equivalent Dose for the target contaminant in a first region of the electromagnetic spectrum having a wavelength of less than or equal to about 240 nm.

24-25. (canceled)

26. The process defined in claim 9, wherein Step (a) comprises determining a short wavelength Reduction Equivalent Dose for a challenge contaminant in the first region of the electromagnetic spectrum.

27. (canceled)

28. The process defined in claim 26, wherein the challenge contaminant is a microorganism.

29. (canceled)

30. The process defined in claim 26, wherein the challenge contaminant is bacteriophage MS2.

31. The process defined in claim 9, wherein Step (a) comprises:
exposing a sample of fluid containing a prescribed concentration of the target contaminant or the challenge contaminant to radiation;
measuring the intensity of the radiation using a first sensor configured to sense a peak radiation intensity in the first region of the electromagnetic spectrum to produce a first measured intensity; and
calculating the short wavelength Reduction Equivalent Dose from the first measured intensity.

32-33. (canceled)

34. The process defined in claim 9, wherein Step (b) comprises:
exposing a sample of fluid containing a prescribed concentration of the target contaminant or the challenge contaminant to radiation;
measuring the intensity of the radiation using a second sensor configured to sense a peak radiation intensity in the second region of the electromagnetic spectrum to produce a second measured intensity; and
calculating the long wavelength Reduction Equivalent Dose from the second measured intensity.

35-36. (canceled)

37. A process for maintaining a prescribed dose of radiation in a fluid treatment system comprising (i) a flow of fluid comprising a target contaminant, and (ii) at least one polychromatic radiation source configured to expose the target contaminant to radiation, the process comprising the steps of:
(a) determining an actual Reduction Equivalent Dose of radiation to which the target contaminant is exposed;
(b) comparing the actual Reduction Equivalent Dose of radiation to a validated Reduction Equivalent Dose obtained according to the process defined in claims 1-36; and
(c) adjusting output of the at least one polychromatic radiation source to substantially compensate for any difference between the actual Reduction Equivalent Dose of radiation and the validated Reduction Equivalent Dose.

38. The process defined in claim 37, wherein the at least one polychromatic radiation source an ultraviolet radiation source.

39. (canceled)

40. The process defined in claim 37, wherein the target contaminant is a chemical compound characterized in undergoing photolysis (with or without a catalyst) when exposed to radiation having at least one wavelength in at least one of the first region of the electromagnetic spectrum and the second region of the electromagnetic spectrum.

41-44. (canceled)

45. The process defined in claim 37, wherein the target contaminant is a microorganism.

46-52. (canceled)

53. The process defined in claim 37, wherein Step (a) comprises:
determining an actual short wavelength Reduction Equivalent Dose;
determining an actual long wavelength Reduction Equivalent Dose; and
summing the actual short wavelength Reduction Equivalent Dose and the actual long wavelength Reduction Equivalent Dose to produce the actual Reduction Equivalent Dose.

54-59. (canceled)

60. A system for maintaining a prescribed dose of radiation in a fluid treatment system comprising: (i) a flow of fluid comprising a target contaminant, and (ii) at least one polychromatic radiation source configured to expose the target contaminant to radiation, the system comprising:
(a) a first sensor configured to sense a peak radiation intensity (preferably only) in a first region of the electromagnetic spectrum having a wavelength of less than or equal to about 240 nm to produce a first measured intensity;
(b) a second sensor configured to sense a peak radiation intensity (preferably only) in a first region of the electromagnetic spectrum having a wavelength of greater than about 240 nm to produce a second measured intensity;
(c) a controller element configured to:
compare an actual Reduction Equivalent Dose to a validated Reduction Equivalent Dose obtained according to the process defined in claims 1-36; and
adjust the output of the at least one polychromatic radiation source to substantially compensate for any difference between the actual Reduction Equivalent Dose of radiation and the validated Reduction Equivalent Dose.

61. The system defined in claim 60, wherein the controller element is configured to:
calculate an actual short wavelength Reduction Equivalent Dose from the first measured intensity;
calculate an actual long wavelength Reduction Equivalent Dose from the second measured intensity;
sum the actual short wavelength Reduction Equivalent Dose and the actual short wavelength Reduction Equivalent Dose to produce an actual Reduction Equivalent Dose;
compare the actual Reduction Equivalent Dose to a validated Reduction Equivalent Dose obtained according to the process defined in claims 1-36; and
adjust the output of the at least one polychromatic radiation source to substantially compensate for any difference between the actual Reduction Equivalent Dose of radiation and the validated Reduction Equivalent Dose.

62-65. (canceled)

66. The process defined in claim 60, wherein the at least one polychromatic radiation source an ultraviolet radiation source.

67. (canceled)

68. The process defined in claim 60, wherein the target contaminant is a chemical compound characterized in undergoing photolysis (with or without a catalyst) when exposed to radiation having at least one wavelength in at least one of the first region of the electromagnetic spectrum and the second region of the electromagnetic spectrum.

69-72. (canceled)

73. The process defined in claim 60, wherein the target contaminant is a microorganism.

74-80. (canceled)
